(19) United States
(12) Patent Application Publication
(10) Pub. No.: US 2024/0334514 A1
(43) Pub. Date: Oct. 3, 2024

(54) COORDINATED IDLE PERIOD MANAGEMENT FOR MULTI-LINK OPERATIONS

(71) Applicant: Cisco Technology, Inc., San Jose, CA (US)

(72) Inventors: Sachin D. WAKUDKAR, St-Sulpice (CH); Ardalan ALIZADEH, Milpitas, CA (US); Shailender POTHARAJU, Fremont, CA (US); Ugo M. CAMPIGLIO, Morges (CH); Jerome HENRY, Pittsboro, NC (US)

(21) Appl. No.: 18/295,208

(22) Filed: Apr. 3, 2023

(51) Int. Cl. H04W 76/15; H04W 76/38

(52) U.S. Cl. CPC H04W 76/15; H04W 76/38; H04W 88/10

(57) ABSTRACT

Techniques for improved multi-link operations are provided. A first link between a first access point (AP) multi-link device (MLD) and a non-AP MLD is established. A first idle timeout timer is generated for the first link, and an indication of one or more links between the non-AP MLD and a second AP MLD is received from the non-AP MLD. An indication of the first link is transmitted to the second AP MLD and from the first AP MLD. In response to determining that one or more link termination criteria are satisfied with respect to the first link, the first link is terminated, where subsequent to terminating the first link, the non-AP MLD continues to exchange data with the second AP MLD using the one or more links.

### TECHNICAL FIELD

Embodiments presented in this disclosure generally relate to multi-link operations. More specifically, embodiments disclosed herein relate to coordinated idle period management in multi-link operations.

### BACKGROUND

Multi-link operations (MLO) generally refers to technologies that enable devices (sometimes referred to as multi-link devices or MLDs) to send and receive data (e.g., packets) using multiple different links, either simultaneously (e.g., STR MLO) or non-simultaneously (e.g., non-STR MLO). For example, an MLD may use multiple frequency bands and/or channels to perform MLO (e.g., a first link in the 2.4 GHz band and a second link in the 5 GHz band).

Many wireless local area networks (WLANs), such as WiFi networks, use maximum idle period management to automatically disconnect devices that are idle (e.g., that have not sent or received a frame during a defined period of time). Generally, when association is for a multi-link setup, the max idle period management service enables an access point (AP) MLD to indicate the max idle time period during which the AP MLD will not disassociate a non-AP MLD due to non-receipt of frames from the non-AP MLD on any of the links. That is, the non-AP MLD may be idle up until the max idle period is reached without being disassociated. After the max idle period is reached, however, the AP MLD may terminate all links to the non-AP MLD and disassociate the non-AP MLD. This idle period supports improved power efficiency at the non-AP MLD, as well as improved resource management at the AP MLD, but allows for non-AP MLDs to be erroneously disassociated in some cases due to inactivity on a link.

Additionally, non-AP MLDs may establish two or more links with an AP MLD to satisfy some application bandwidth requirements at association. At a later time, these requirements might change. However, the allocated links are maintained even if no longer needed, and the non-AP MLD must re-associate to reconfigure the links.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for MLO idle period coordination, according to some embodiments of the present disclosure.

FIG. 2 depicts an example workflow for MLO idle period coordination between AP MLDs, according to some embodiments of the present disclosure.

FIG. 3 depicts an example workflow for dynamic MLO idle periods, according to some embodiments of the present disclosure.

FIG. 4 is a flow diagram depicting an example method for MLO idle period coordination, according to some embodiments of the present disclosure.

FIG. 5 is a flow diagram depicting an example method for dynamic MLO idle periods, according to some embodiments of the present disclosure.

FIG. 6 is a flow diagram depicting an example method for MLO operations, according to some embodiments of the present disclosure.

FIG. 7 is a flow diagram depicting an example method for dynamic MLO, according to some embodiments of the present disclosure.

FIG. 8 is a flow diagram depicting an example method for MLO coordination, according to some embodiments of the present disclosure.

FIG. 9 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method for dynamic multi-link allocation with independent idle timeout timers, including establishing, by a first access point (AP) multi-link device (MLD), a first link between the first AP MLD and a non-AP MLD, generating a first idle timeout timer for the first link, receiving, from the non-AP MLD, an indication of one or more links between the non-AP MLD and a second AP MLD, and transmitting, to the second AP MLD and from the first AP MLD, an indication of the first link; and in response to determining that one or more link termination criteria are satisfied with respect to the first link, terminating the first link, wherein subsequent to terminating the first link, the non-AP MLD continues to exchange data with the second AP MLD using the one or more links.

One embodiment presented in this disclosure provides a method for idle timeout coordination between wireless access points, including establishing, by a first access point (AP) multi-link device (MLD), a first link between the first AP MLD and a non-AP MLD, generating a first idle timeout timer for the non-AP MLD with respect to the first AP MLD, transmitting, to a second AP MLD, a first value of the first idle timeout timer, receiving, from the second AP MLD, a second value of a second idle timeout timer associated with the non-AP MLD with respect to the second AP MLD, and in response to determining that the second value is greater than the first value, setting the first idle timeout timer to the second value.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### Example Embodiments

Embodiments of the present disclosure provide methods, systems, and techniques for improved MLO coordination and idle management.

Some embodiments of the present disclosure provide techniques for improved idle timeout periods for multi-AP MLO. For example, in one embodiment, AP MLDs can coordinate on idle timeouts to improve MLO with respect to non-AP MLDs. Such coordination, as described below, can prevent a non-AP MLD from being disconnected by an AP MLD for reaching an idle timeout on one link while another link (and stream) is active with another AP MLD. That is, if the non-AP MLD uses two links (one to each of two AP MLDs) and is idle on one link (to one AP MLD) while using a second link (to the second AP MLD), the AP MLDs may coordinate/share their idle timers to ensure that the non-AP MLD is not disconnected so long as it continues to use at least one link to at least one AP MLD, even if it is idle on another link to another AP MLD.

As another example for improved idle timeout periods for multi-AP MLO, some embodiments enable dynamic MLD allocation and/or independent idle timeout management across links. In some existing standards (e.g., 802.11be), establishment of MLD links is allowed only at association. That is, a non-AP MLD must establish all desired links at association, and cannot subsequently add (or remove) any links without requiring re-association for all links. This constraint is limiting on flexibility and can result in resource waste. For example, a non-AP MLD may have different throughput requirements while in a MLO environment. Therefore, the optimal number of links may vary over the connection lifetime.

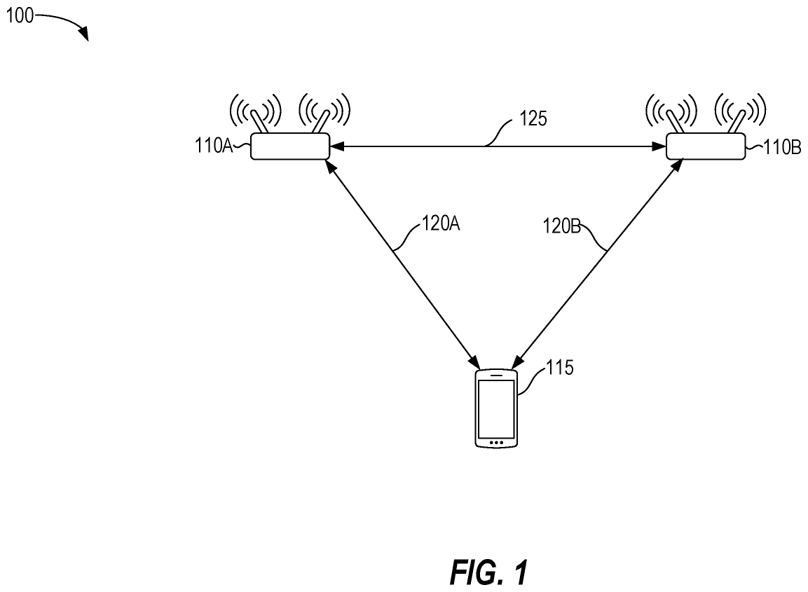

FIG. 1 depicts an example environment 100 for MLO idle period coordination, according to some embodiments of the present disclosure. The illustrated environment 100 includes a client device 115 (which may be referred to in some embodiments as a non-AP MLD) and two APs 110A and 110B (which may be referred to as AP MLDs in some embodiments). Generally, the client device 115 may correspond to a variety of devices, such as smartphones, tablets, IoT devices, and the like. Although a single client device 115 is depicted for conceptual clarity, in embodiments, there may be any number and variety of client devices (some of which may be MLDs, and some of which may not be MLDs). Similarly, though two APs 110 are depicted for conceptual clarity, in embodiments, there may be any number of APs.

In some embodiments, the APs 110 are part of a single WLAN. Although not depicted in the illustrated example, in some embodiments, the APs 110 may be managed by and/or exchange information via a controller component (e.g., a WLAN controller (WLC)).

In the illustrated example, the APs 110 are communicatively coupled via a connection 125 which they can use to share various information, as discussed in more detail below. The connection 125 may generally include one or more wired or wireless connections, and may be direct (e.g., directly connecting the APs 110A and 110B) and/or indirect (e.g., connecting the APs via one or more intermediate devices or components, such as a WLC).

Additionally, in the illustrated example, the client device 115 is communicatively coupled to each AP 110 via a corresponding link 120. That is, the client device 115 is a non-AP MLD that has one link 120A to a first AP 110A and a second link 120B to a second AP 110B. Although two links 120 are depicted for conceptual clarity, in embodiments, the client device 115 may use any number of links to any number of APs 110 (including multiple links to a single AP 110, in some embodiments).

In some embodiments, as discussed above, the APs 110 may coordinate idle timeout timers to improve MLO with the client device 115. In one such embodiment, when a non-AP MLD (such as the client device 115) is connected to two (or more) different physical AP MLDs (e.g., APs 110) at the same time (e.g., with a link 120 to each), each AP 110 may maintain an idle timeout for the MLD link(s) it owns (the links from the respective AP 110 to the client device 115). That is, the AP 110A may maintain a first idle timeout timer with respect to the client device 115, and the AP 110B may maintain a second idle timeout timer with respect to the client device 115.

In an embodiment, the APs 110 may exchange information (e.g., periodically) via the connection 125, indicating the status of the connected client device(s) 115 with each other. Among other information, the current idle timeout value for each client device 115 may be exchanged. In some embodiments, the current idle timeout can be defined as the maximum idle timeout minus the time since the last packet was received from or sent to (and acknowledged by) the client device 115. That is, the AP 110B may indicate its current idle timeout value (with respect to the client device 115) to the AP 110A, and vice versa.

In some embodiments, when an AP 110 receives this idle timer information on the status of a connected client device from another AP 110, the AP 110 can compare the indicated timeout value to its own idle timeout for the same client device 115 (if connected). That is, in response to receiving the idle timeout value(s) the AP 110B, the AP 110A may determine whether any of the indicated client devices are also connected to the AP 110A. If so, the AP 110 A can compare its own idle timer value(s) with respect to the connected client device(s) 115 to the value(s) provided by the AP 110B for the client device(s).

In some embodiments, each AP 110 then updates its own idle timeout timer if the other AP 110 reported a higher value. That is, the AP 110A may reset its own idle timeout value to the reported value from the other AP 110B if the value reported by the AP 110B is greater than the idle timeout timer of the AP 110A, and vice versa. In this way, all APs 110 having one or more links to the client device 115 can synchronize their idle timeout timers with respect to the client device 115. This can prevent the client device 115 from being disconnected because it is idle with respect to one AP 110, as long as it is active with another AP 110.

In some embodiments, as discussed above, the APs 110 may enable the client device 115 to use dynamic link creation and termination as well as active or dynamic management of idle timeout timers. That is, in some embodiments, the establishment of MLD links is extended to any time (rather than solely at association), where the devices can use a separate association procedure for each link (and, in some embodiments, the association frame can contain information about any pre-existing links). In some embodiments, any link can be torn down by the AP 110 or the client device 115 without affecting other links to the same AP 110 or to other APs 110.

In some embodiments, the client device 115 can complete an association and authentication exchange for each new desired link 120. In one embodiment, during the association, the client device 115 can send, to the AP 110, identifiers of any already existing MLO links 120 (and, in some aspects, the Internet Protocol (IP) address(es) of the APs 110 with which the links are established). In some embodiments, the AP 110 can then exchange link information with the indicated other AP(s) 110 that have links 120 with the client device 115, such as to indicate that a new link 120 is being established between the client device 115 and the AP 110.

In some embodiments, the client device 115 may tear down links 120 when they are no longer needed. In such an embodiment, tearing down a link 120 to a given AP 110 does not affect the status of the other links 120 that the client device 115 is using (to the same AP 110 and/or to other APs 110). In at least one embodiment, the AP 110 of the torn link can notify other APs 110 that the link 120 is no longer active.

In some embodiments, each AP 110 can maintain an idle timeout for the client device 115 and/or for each specific link to the AP 110. If the idle timeout is reached, the link 120 can be terminated by the AP 110. In an embodiment, this termination does not affect other active links of the client device 115 (to the same AP 110 or to other APs 110).

In an embodiment, if the client device 115 desires additional bandwidth again, it can re-establish the additional link(s) 120 to one or more APs 110 at any time. In some embodiments, therefore, the idle timeout can be used to save energy and release resources allocated for the client device 115 as well as for the APs 110 when they are no longer necessary. In some embodiments, the idle timeout no longer disconnects the client device 115 entirely, unless a timeout expiring results in tearing down the last active link 120 for the client device 115. That is, the client device 115 can continue to use any other active links 120, and is not disconnected because the idle timeout is hit for a single link 120.

Generally, using embodiments of the present disclosure, idle timeout and MLO management can be substantially improved, resulting in improved efficiency, reduced resource waste, and overall enhanced operations of the client device 115 and APs 110.

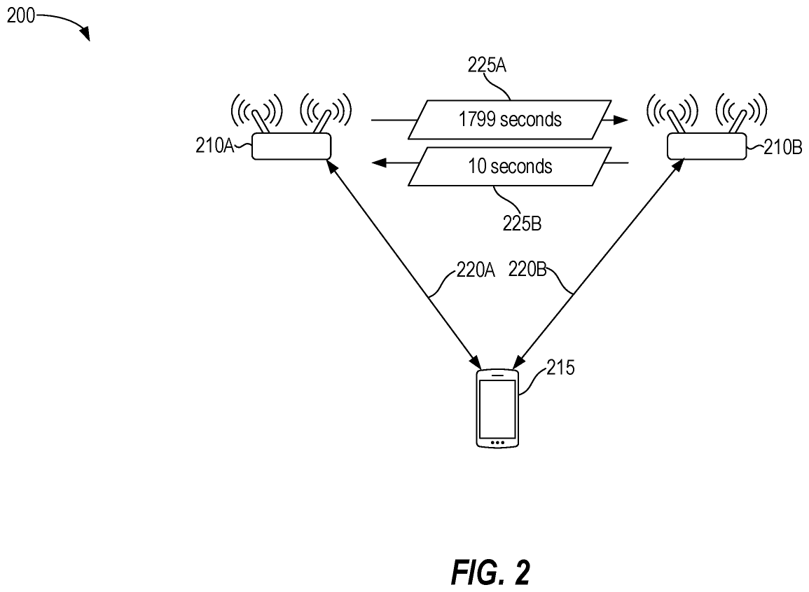

FIG. 2 depicts an example workflow 200 for MLO idle period coordination between AP MLDs, according to some embodiments of the present disclosure. The illustrated workflow 200 includes a client device 215 (which may correspond to the client device 115 of FIG. 1) and two APs 210A and 210B (which may correspond to the APs 110 of FIG. 1). Although a single client device 215 is depicted for conceptual clarity, in embodiments, there may be any number and variety of client devices (some of which may be MLDs, and some of which may not be MLDs). Similarly, though two APs 210 are depicted for conceptual clarity, in embodiments, there may be any number of APs.

In the illustrated example, the APs 210 are communicatively coupled via one or more connections, which may generally include one or more wired or wireless connections, and may be direct or indirect. Additionally, in the illustrated example, the client device 215 is communicatively coupled to each AP 210 via a corresponding link 220. That is, the client device 215 is a non-AP MLD that has one link 220A to a first AP 210A and a second link 220B to a second AP 210B. Although two links 220 are depicted for conceptual clarity, in embodiments, the client device 215 may use any number of links to any number of APs 210 (including multiple links to a single AP 210, in some embodiments).

In the illustrated example, each AP 210 shares its timeout timer value(s) for any connected client devices 215, as indicated by transmissions 225A and 225B. Specifically, as illustrated, the AP 210A indicates, to the AP 210B, that the idle timeout timer for the client device 215 (communicating via link 220A) has 1799 seconds remaining. That is, if the AP 210A does not send or receive any data to or from the client device 215 in the next 1799 seconds, the AP 210A will terminate the link 220A as inactive. Until then, the link 220A remains alive. In some embodiments, the AP 210A may refresh or reset its idle timer whenever it receives data from the client device 215 (or receives acknowledgement of data it transmitted to the client device 215).

Similarly, the AP 210B indicates, to the AP 210A, that the idle timeout timer for the client device215 (communicating via link 220B) has 10 seconds remaining. That is, if the AP 210B does not send or receive any data to or from the client device 215 in the next 10 seconds, the AP 210B will terminate the link 220B as inactive. Until then, the link 220B remains alive. In some embodiments, the AP 210B may refresh or reset its idle timer whenever it receives data from the client device 215 (or receives acknowledgement of data it transmitted to the client device 215).

In the illustrated example, each AP 210 compares the received idle timeout timer value with its own idle timeout timer value. For example, AP 210A determines that the received idle timeout timer value of 10 seconds is lower than its own value of 1799 seconds, and therefore determines to take no action (e.g., to refrain from resetting its own idle timeout), because the client device 215 is relatively more active on the link 220A than on the link 220B. The AP 210B will determine that the received value of 1799 seconds is greater than its own value of 10 seconds. In response, in some embodiments, the AP 210B can reset its own idle timeout timer to a value of 1799 seconds. That is, because the client device 215 is still active on the link 220A (as evidenced by the high idle timeout timer value), the AP 210B can determine to reset its own idle timer value and refrain from tearing down the link 220B until the longest idle timeout timer expires. In this way, both links 220A and 220B remain alive as long as the client device 215 remains active on at least one of them.

In some embodiments, as discussed above, the APs 210 exchange the idle timeout information periodically (e.g., every five seconds). In some embodiments, the APs 210 can exchange this information upon occurrence of other criteria. For example, in one embodiment, the APs 210 transmit and/or request idle timeout timer information from the other AP(s) 210 when their own timer expires (or when their own timer is within a threshold time from expiring, such as within 5 seconds). That is, when the idle timeout timer of the AP 210B expires or is about to expire (e.g., in 10 seconds), the AP 210B may request timer information from the AP 210A to determine whether it has any active links 220 to the client device 215 and/or to determine whether to tear down its own link 220B.

Although the illustrated example depicts two APs 210, in embodiments, the client device 215 may be connected to any number of APs 210. In such embodiments, rather than comparing its own idle timeout value to a single value (received from one other AP 210), each AP 210 may compare its value to all other idle timeout values that are received.

Additionally, although a single client device 215 is depicted for conceptual clarity, there may be multiple such client devices 215. In some embodiments, therefore, the transmissions 225 may indicate a set of idle timeout timer values, one for each connected client device 215. Each AP 210 may then evaluate the received set to determine whether any of the indicated client devices 215 are also connected to the AP 210. If so, the AP 210 may compare the idle timer values, as discussed above, to determine whether to reset the value for the specific client device.

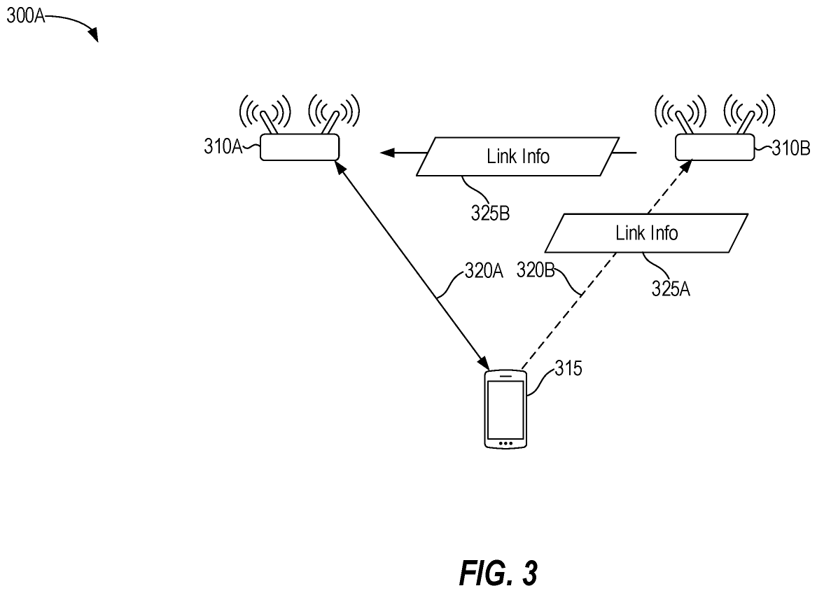

FIG. 3 depicts an example workflow 300 for dynamic MLO idle periods, according to some embodiments of the present disclosure. The illustrated workflow 300 includes a client device 315 (which may correspond to the client device 115 of FIG. 1 and/or the client device 215 of FIG. 2) and two APs 310A and 310B (which may correspond to the APs 110 of FIG. 1 and/or the APs 210 of FIG. 2). Although a single client device 315 is depicted for conceptual clarity, in embodiments, there may be any number and variety of client devices (some of which may be MLDs, and some of which may not be MLDs). Similarly, though two APs 310 are depicted for conceptual clarity, in embodiments, there may be any number of APs.

In the illustrated example, the APs 310 are communicatively coupled via one or more connections, which may generally include one or more wired or wireless connections, and may be direct or indirect. Additionally, in the illustrated example, the client device 315 is communicatively coupled to one or more APs 310 via corresponding links 320.

In the illustrated example, the client device 315 has an existing link 320A with AP 310A. Additionally, as illustrated, the client device 315 is seeking to establish an MLO link 320B with the AP 310B. As discussed above, the client device 315 may use a separate association procedure to establish the link 320B without affecting the link 320A. In the illustrated example, during this procedure, the client device 315 can transmit link information 325A to the AP 310B (e.g., in an association frame). As discussed above, this link information 325A may indicate, to the AP 310B, any other pre-existing link(s) 320 that the client device 315 already has. Specifically, in the illustrated example, the link information 325A may indicate that the client device 315 already has link 320A to the AP 310A.

As illustrated, during or after establishing the link 320B, the AP 310B can transmit link information 325B to the AP 310A. That is, the AP 310B may identify any APs 310 specified in the link information 325A, and transmit updated link information 325B to each such AP. In an embodiment, the link information 325B can generally indicate that the link 320B has been or is being established. The AP 310A can thereby update its own records to reflect the new link 320B.

In some embodiments, the APs 310 may use these records to share or coordinate on idle timeout values, as discussed above. In some embodiments, the APs 310 use these records to determine which other AP(s) should be updated if any changes occur to its own links. For example, if the link 320A is torn down by the AP 310A and/or the client device 315, the AP 310A may determine to inform the AP 310B that the link 320A is no longer active (because the AP 310B still has a link 320B). Subsequently, if the link 320B is torn down (or another link is established between the client device 315 and the AP 310B), the AP 310B may know that it need not update the AP 310A.

Similarly, if a new link is established between the AP 310A and the client device 315, the AP 310A may determine to inform the AP 310B that the new link is now active. Generally, whenever link changes occur, each AP 310 may update other AP(s) that also have link(s) to the same client device 315.

In some embodiments, as discussed above, each link 320 and/or AP 310 may use a distinct/independent idle timer. For example, the AP 310A may manage a first idle timeout timer for the link 320A and/or client device 315, and the AP 310B may establish and manage a second idle timeout timer for the link 320B and/or client device 315. In this way, if a given link 320 is torn down (e.g., by the client device 315, or due to expiration of the corresponding idle timeout timer), the other links 320 (if any) may remain unaffected.

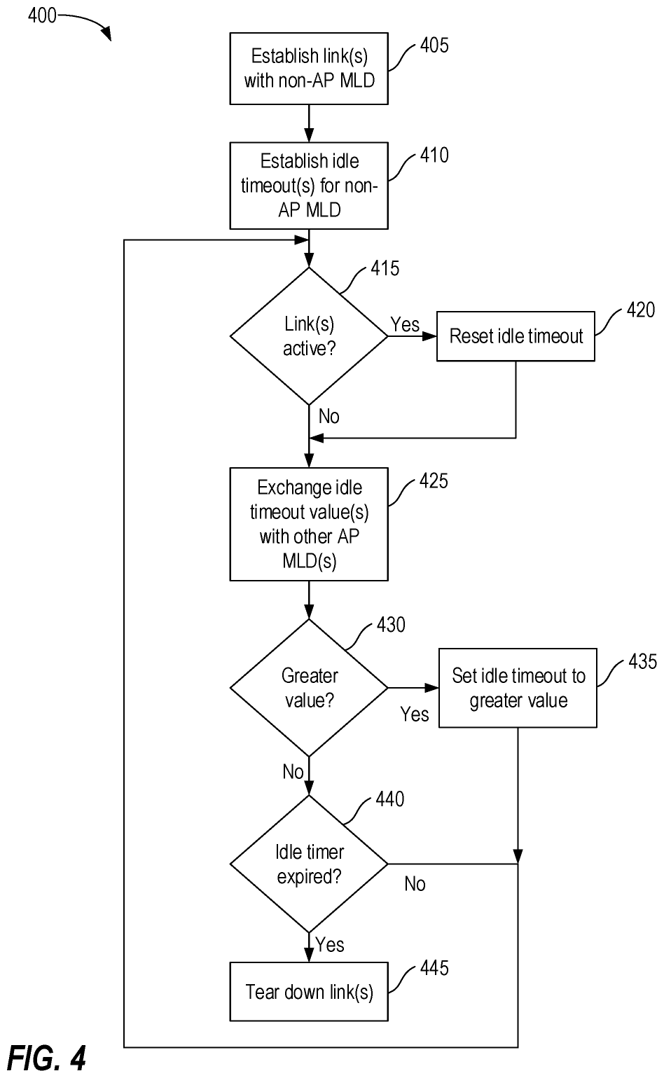

FIG. 4 is a flow diagram depicting an example method 400 for MLO idle period coordination, according to some embodiments of the present disclosure. In some embodiments, the method 400 is performed by an AP, such as an AP 110 of FIG. 1, an AP 210 of FIG. 2, and/or an AP 310 of FIG. 3. In some embodiments, the method 400 provides additional detail for the workflow 200 of FIG. 2.

At block 405, the AP establishes one or more links with a non-AP MLD (e.g., with a client device 115 if FIG. 1, client device 215 of FIG. 2, and/or client device 315 of FIG. 3). For example, as discussed above, the AP may establish MLO link(s) with the non-AP MLD (which may or may not already have one or more links to one or more other APs and/or to the AP performing the method 400).

At block 410, the AP establishes one or more idle timeout timers for the non-AP MLD and/or for each individual link, as discussed above. For example, the AP may determine a defined maximum idle time (e.g., configured by an administrator or controller), and establish, initiate, or start a timer with this maximum value.

At block 415, the AP determines whether the link(s) to the non-AP MLD are active. For example, the AP may determine whether data was received, from the non-AP MLD, via the link(s). In some embodiments, the AP may similarly determine whether data that it sent to the non-AP MLD (via the link(s)) was acknowledged by the non-AP MLD. If the non-AP MLD sent data and/or an acknowledgement, the AP determines that the link(s) are active, and the method 400 continues to block 420 where the AP resets the idle timeout timer(s). For example, the AP may reset the idle timer to the maximum idle time value. The method 400 then continues to block 425.

Returning to block 415, if the AP determines that the link is not currently active (e.g., the AP did not send or receive data via the link(s) since the last iteration of the method 400), the method 400 continues to block 425 without resetting the idle timeout timer.

At block 425, the AP exchanges idle timeout value(s) for its connected non-AP MLD(s) with one or more other AP MLD(s), as discussed above. In some embodiments, this includes sharing the idle timeout timer with other APs that already have a link with the client device (e.g., determined via shared link information, as discussed above). In some embodiments, the AP can share the timeout values with all neighbor APs, allowing each to determine whether it has a link with the indicated client.

In addition to transmitting or sharing idle values, at block 425, the AP also receives idle timeout value(s) from one or more other AP(s). For example, as discussed above, each AP may periodically share idle timeout timer values with all neighbor APs and/or with any neighbor APs that have link(s) to the same connected device.

At block 430, the AP determines whether any of the received idle timeout values (from one or more other APs), with respect to the same non-AP MLD, are greater than the idle timeout value of the AP itself. That is, as discussed above, the AP can determine whether the client device is currently active on another link to another AP (or was active more recently on the other link, as compared to the link(s) to the AP).

If so, the method 400 continues to block 435, where the AP sets its own idle timeout timer for the client device (or for each link) to the greater value received from the other AP(s). In this way, the AP effectively refreshes its own idle timeout, allowing the client to maintain the link(s) to the AP even when it is idle or inactive on those links, as long as it remains active on one or more other links to one or more other APs. The method 400 then returns to block 415.

Returning to block 430, if the AP determines that none of the other idle timeout values are greater than its own (e.g., the client device was active on the link(s) with the AP more recently than on any other links to other APs), the method 400 continues to block 440. At block 440, the AP determines whether its own idle timer is expired. That is, the AP can determine whether its idle timeout timer has reached a value of zero, whether the maximum idle time has passed without active data on the link(s), and the like. If, at block 440, the AP determines that the idle timer is not expired, the link(s) remain active/alive and the method 400 returns to block 415.

If, at block 440, the AP determines that the idle timeout timer has expired, the method 400 continues to block 445, where the AP tears down the link(s) between itself and the non-AP MLD (the client device). In this way, the AP only tears down its own links when no other active links remain between the client device and any of the APs. This can enhance the operations of the client device (which does not lose any links simply because it is active with another AP) as well as the APs (enabling them to tear down links only when the client is truly inactive, preventing inappropriate link tear down).

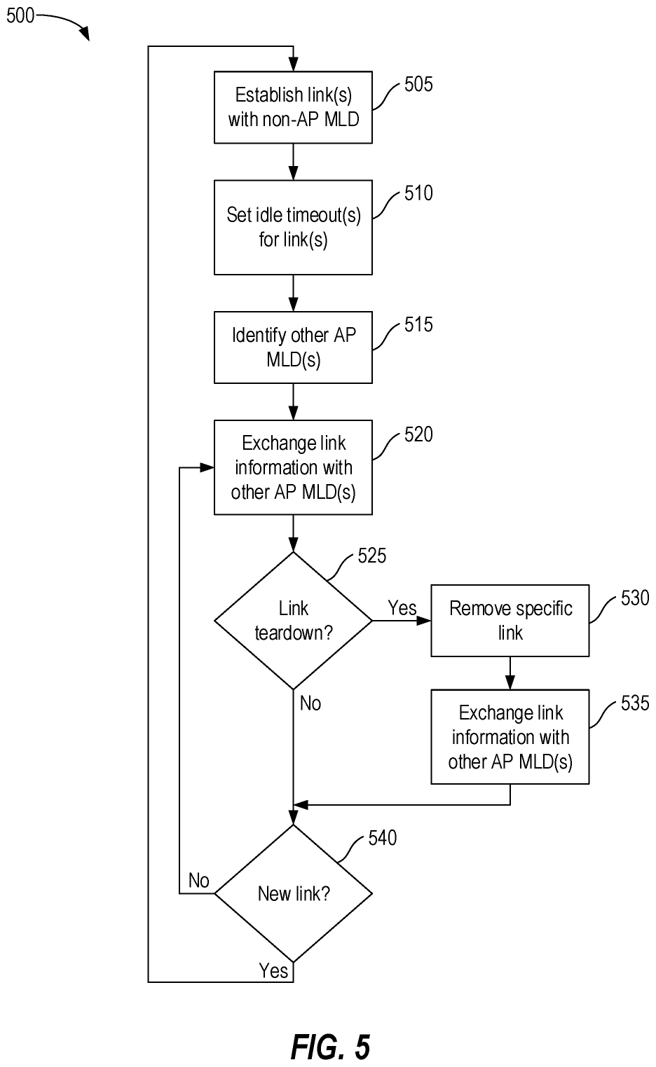

FIG. 5 is a flow diagram depicting an example method 500 for dynamic MLO idle periods, according to some embodiments of the present disclosure. In some embodiments, the method 500 is performed by an AP, such as an AP 110 of FIG. 1, an AP 210 of FIG. 2, and/or an AP 310 of FIG. 3. In some embodiments, the method 500 provides additional detail for the workflow 300 of FIG. 3.

At block 505, the AP establishes one or more links with a non-AP MLD (e.g., with a client device 115 if FIG. 1, client device 215 of FIG. 2, and/or client device 315 of FIG. 3). For example, as discussed above, the AP may establish MLO link(s) with the non-AP MLD (which may or may not already have one or more links to one or more other APs and/or to the AP performing the method 500).

At block 510, the AP sets or establishes one or more idle timeout timers for the links, as discussed above. For example, the AP may determine a defined maximum idle time (e.g., configured by an administrator or controller), and establish, initiate, or start one or more timers (e.g., one for each link) with this maximum value.

At block 515, the AP identifies any other AP MLD(s) that also have one or more links with the non-AP MLD. For example, as discussed above, the non-AP MLD may indicate, during association, the set of existing link(s) it has with any other APs.

At block 520, the AP can exchange link information with the identifier other AP(s). For example, as discussed above, the AP may indicate the presence of the newly established link(s) (established at block 505) to the other APs. This allows the other APs to update their records to reflect the new set of links that the non-AP MLD has. In some embodiments, as discussed above, this link information can further include the idle timeout timers for any links on the other APs.

At block 525, the AP determines whether to tear down any of its links. For example, the AP may determine whether an idle timeout timer has expired with respect to the non-AP MLD and/or with respect to any individual link, whether the AP has determined to tear down a link for other reasons (e.g., load balancing or shedding), whether the non-AP MLD has requested to tear down a link, and the like. If, at block 525, the AP determines not to tear down any of the links to the non-AP MLD, the method 500 continues to block 540.

If, at block 525, the AP determines to tear down one or more links, the method 500 continues to block 530, where the AP removes the specific link(s) that it determined, at block 525, to teardown. That is, the AP may remove one or more specific links, and may leave one or more other links between itself and the non-AP MLD unaffected. In this way, the non-AP MLD may continue to communicate with the AP using an unaffected/remaining links, even after one or more other links are torn down.

At block 535, the AP again exchanges link information with the identified other AP(s) that also have one or more links with the non-AP MLD. For example, the AP may indicate, to the other AP(s), that it tore down one or more links (identifying the specific links) and/or may indicate the remaining/still active links (if any). In some embodiments, as discussed above, this link information can further include the idle timeout timers for any remaining links. The other APs can then update their own records for future use, and the method 500 continues to block 540.

At block 540, the AP determines whether to establish one or more new links with the non-AP MLD. For example, the AP may determine whether the non-AP MLD has requested or initiated an association procedure to establish a new link to the AP (without affecting the other link(s) with the AP). If not, the method 500 returns to block 520, where the AP can exchange information with the other APs (e.g., to receive updates if any other links have been torn down or created on the other APs) before proceeding to block 525.

If, at block 540, the AP determines that a new link is being or should be established, the method 500 returns to block 505 to begin anew.

In this way, the AP can provide dynamic link creation and teardown without affecting other link(s) between the AP and the client and/or between other APs and the client. Additionally, by sharing link information and idle timeout timers, the APs can coordinate and generally improve the operations of the APs and the non-AP MLD, as discussed above.

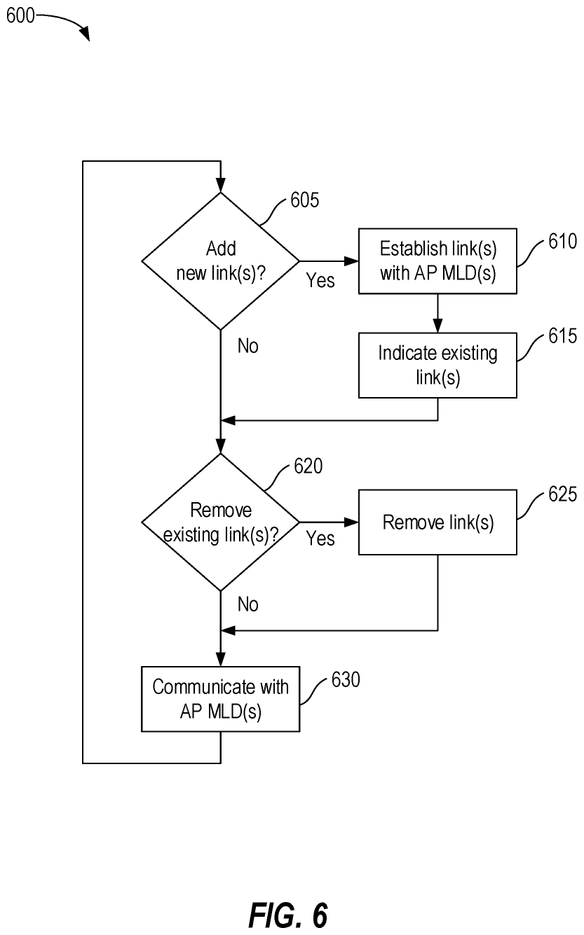

FIG. 6 is a flow diagram depicting an example method 600 for MLO operations, according to some embodiments of the present disclosure. In some embodiments, the method 600 is performed by a client device, such as client device 115 of FIG. 1, client device 215 of FIG. 2, and/or client device 315 of FIG. 3.

At block 605, the client device determines whether to add one or more MLO links to one or more APs. For example, as discussed above, the client device may determine whether to add link(s) based on its communication needs or desires (e.g., the bandwidth needed for one or more applications), based on its physical position or movement in the space (e.g., if roaming), and the like. If, at block 605, the client device determines not to add one or more new links, the method 600 continues to block 620.

If, at block 605, the client device determines to establish one or more new link(s), the method 600 continues to block 610. At block 610, the client device establishes one or more links with one or more AP MLDs. For example, as discussed above, the client device may undergo an association procedure to establish the new links.

At block 615, as part of this association/link establishment, the client device can indicate any existing link(s) it already has, as discussed above. For example, the client device may indicate, to the AP MLD(s) with which the new link(s) are being established, the set of existing link(s) it already has, as well as the AP(s) with which each link is associated. The method 600 then continues to block 620. As discussed above, the APs may use this link information to coordinate among themselves in order to improve the operations and service of the network to the client device.

At block 620, the client device determines whether to remove one or more existing links. For example, as discussed above, the client device may determine whether to remove link(s) based on its communication needs or desires (e.g., the bandwidth needed for one or more applications), based on its physical position or movement in the space (e.g., if roaming), and the like. In some embodiments, the client device determines whether to remove links based on determining whether an AP has terminated any of the links (e.g., due to idle timeout). If, at block 620, the client device determines not to remove one or more links, the method 600 continues to block 630.

If, at block 620, the client device determines to remove one or more links, the method 600 continues to block 625. At block 625, the client device removes the one or more links to one or more APs. This may include, for example, informing the AP(s) that they can remove the link(s) and/or that the client device does not need or intend to use the link(s). The method 600 then continues to block 630. In some embodiments, as discussed above, the affected AP(s) may exchange information with each other (and with non-affected APs) to indicate the new link statuses.

At block 630, the client device communicates with one or more AP MLD(s) using one or more link(s) it retains. That is, adding and/or removing link(s) to one or more AP MLD(s) may be performed without affecting the existing link(s) that are not removed. In this way, the client device can dynamically establish and eliminate MLO links as needed/desired, significantly improving flexibility. The method 600 then returns to block 605.

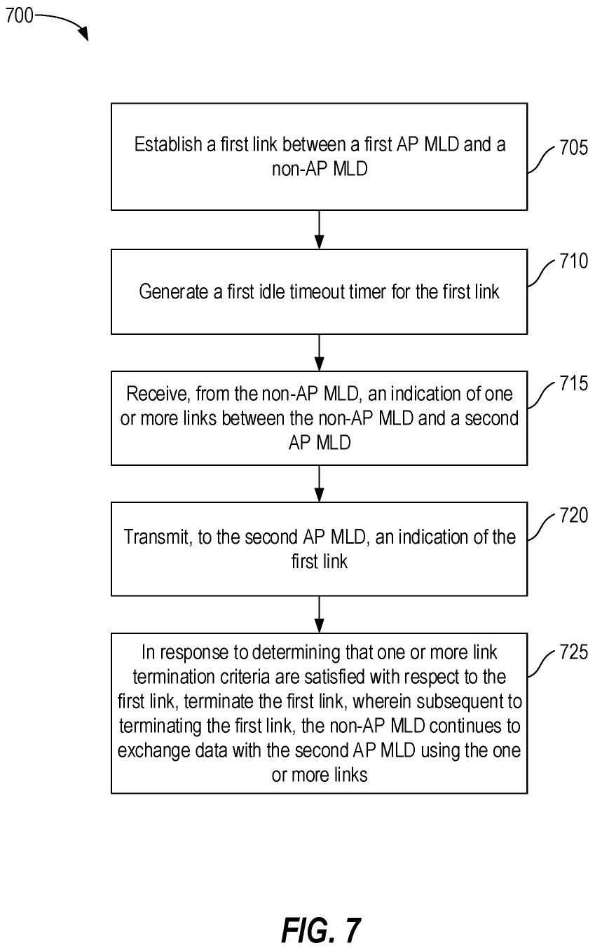

FIG. 7 is a flow diagram depicting an example method 700 for dynamic MLO, according to some embodiments of the present disclosure. In some embodiments, the method 700 is performed by an AP, such as an AP 110 of FIG. 1, an AP 210 of FIG. 2, and/or an AP 310 of FIG. 3.

At block 705, a first link (e.g., link 120 of FIG. 1, link 220 of FIG. 2, and/or link 320 of FIG. 3) between a first AP MLD (e.g., AP 110 of FIG. 1, AP 210 of FIG. 2, and/or AP 310 of FIG. 3) and a non-AP MLD (e.g., client device 115 of FIG. 1, client device 215 of FIG. 2, and/or client device 315 of FIG. 3) is established.

At block 710, a first idle timeout timer is generated for the first link.

At block 715, an indication of one or more links between the non-AP MLD and a second AP MLD is received from the non-AP MLD.

At block 720, an indication of the first link is transmitted to the second AP MLD.

At block 725, in response to determining that one or more link termination criteria are satisfied with respect to the first link, the first link is terminated, wherein subsequent to terminating the first link, the non-AP MLD continues to exchange data with the second AP MLD using the one or more links.

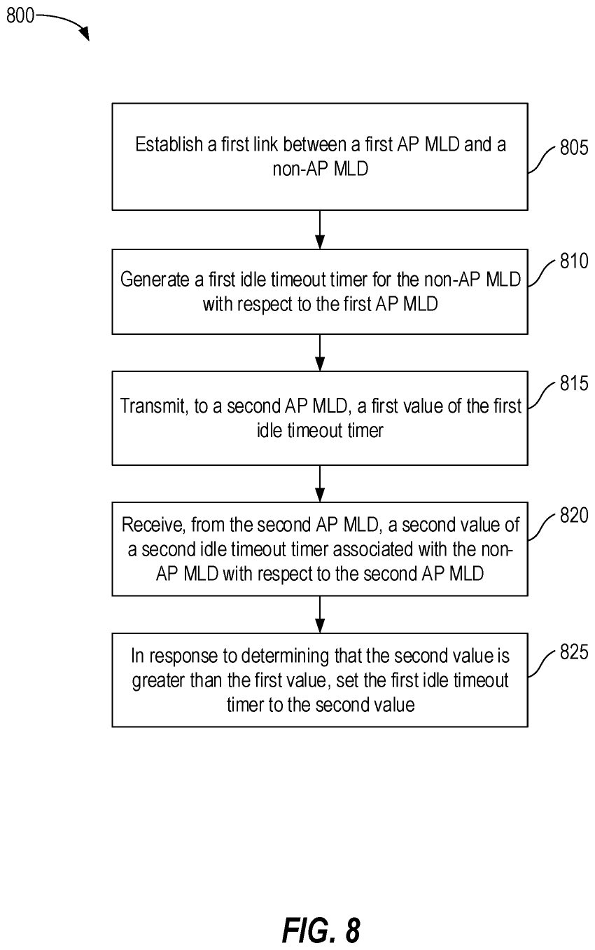

FIG. 8 is a flow diagram depicting an example method 800 for MLO coordination, according to some embodiments of the present disclosure. In some embodiments, the method 700 is performed by an AP, such as an AP 110 of FIG. 1, an AP 210 of FIG. 2, and/or an AP 310 of FIG. 3.

At block 805, a first link (e.g., link 120 of FIG. 1, link 220 of FIG. 2, and/or link 320 of FIG. 3) between a first AP MLD (e.g., AP 110 of FIG. 1, AP 210 of FIG. 2, and/or AP 310 of FIG. 3) and a non-AP MLD (e.g., client device 115 of FIG. 1, client device 215 of FIG. 2, and/or client device 315 of FIG. 3) is established.

At block 810, a first idle timeout timer is generated for the non-AP MLD with respect to the first AP MLD.

At block 815, a first value of the first idle timeout timer is transmitted to a second AP MLD.

At block 820, a second value of a second idle timeout timer associated with the non-AP MLD with respect to the second AP MLD is received from the second AP MLD.

At block 825, in response to determining that the second value is greater than the first value, the first idle timeout timer is set to the second value.

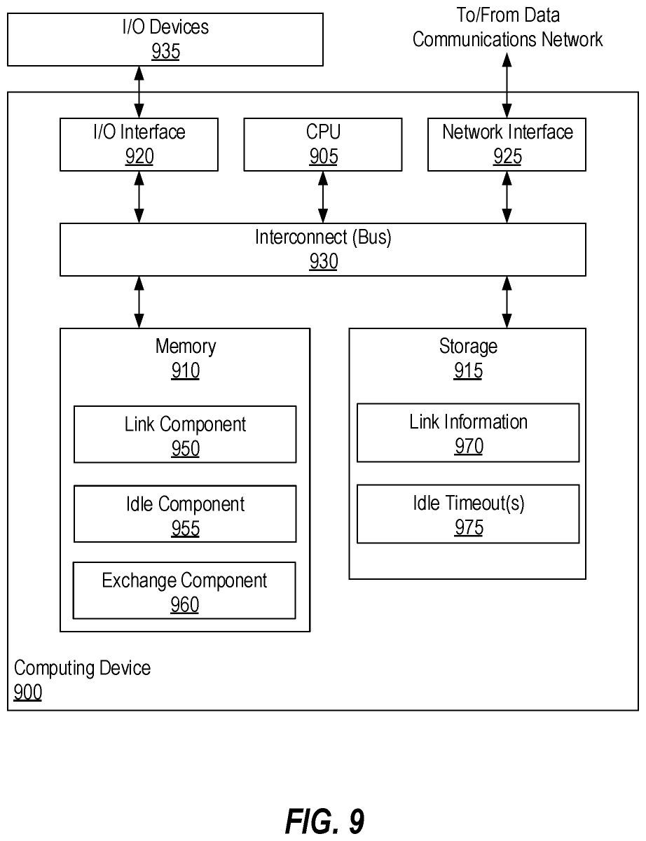

FIG. 9 depicts an example computing device 900 configured to perform various aspects of the present disclosure, according to some embodiments of the present disclosure. Although depicted as a physical device, in embodiments, the computing device 900 may be implemented using virtual device(s), and/or across a number of devices (e.g., in a cloud environment). In one embodiment, the computing device 900 corresponds to an AP, such as an AP 110 of FIG. 1, an AP 210 of FIG. 2, and/or an AP 310 of FIG. 3.

As illustrated, the computing device 900 includes a CPU 905, memory 910, storage 915, a network interface 925, and one or more I/O interfaces 920. In the illustrated embodiment, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally included to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (such as keyboards, monitors, etc.) are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930.

In the illustrated embodiment, the memory 910 includes a link component 950, an idle component 955, and an exchange component 960, which may perform one or more embodiments discussed above. Although depicted as a discrete component for conceptual clarity, in embodiments, the operations of the depicted component (and others not illustrated) may be combined or distributed across any number of components. Further, although depicted as software residing in memory 910, in embodiments, the operations of the depicted component (and others not illustrated) may be implemented using hardware, software, or a combination of hardware and software.

In one embodiment, the link component 950 may be used to establish and/or teardown MLO links with non-AP MLDs, as discussed above. For example, the link component 950 may receive and respond to association requests from non-AP MLDs, as discussed above. In some embodiments, the link component 950 can similarly manage teardown or removal of MLO link(s), such as due to inactivity, for purposes of load balancing or load shedding, in response to requests or indications from the no-AP MLD(s), and the like.

In some embodiments, the idle component 955 can generally be used to establish and/or mange idle timeout timers for non-AP MLD(s) and/or for specific MLO links, as discussed above. For example, the idle component 955 may establish/start an idle timer whenever a new link is created, and may reset or refresh the idle timer for a given link whenever the link is used to send or receive data (or for a given non-AP MLD whenever any link to the non-AP MLD is used). In some embodiments, the idle component 955 can further be used to evaluate idle timeout timer values from other AP(s), and to update its own idle timeouts as needed (e.g., if the other AP has a higher time remaining value), as discussed above.

In some embodiments, the exchange component 960 can be used to exchange link information with other AP(s), as discussed above. For example, the exchange component 960 may indicate the link(s) it has with any given non-AP MLD, the idle timeout value(s) for any such link(s), and the like. Similarly, the exchange component 960 may receive link information (such as identifying specific links and/or idle timeout values) from other AP(s).

In the illustrated example, the storage 915 includes link information 970 and idle timeout(s) 975. In some embodiments, the link information 970 generally indicates which link(s) any given non-AP MLD has active with any number of APs. For example, the link information 970 may indicate the set of existing link(s), each identifying a corresponding AP to which the link is associated. In some embodiments, each time a new link is added and/or an existing link is terminated, the exchange component 960 can update the link information 970. That is, each time the computing device 900 itself updates a link, as well as each time new link information is received from another AP, the exchange component 960 can update the link information 970 accordingly.

In an embodiment, the idle timeout(s) 975 may correspond to idle timeout timers for any link(s) with the computing device 900 and/or any non-AP MLD(s) associated to the computing device 900. That is, the idle timeout(s) 975 may include idle timers on a per-link basis and/or on a per-client basis, as discussed above. Although depicted as residing in storage 915, the link information 970 and idle timeouts 975 may generally be stored in any suitable location, including memory 910.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments, and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for dynamic multi-link allocation with independent idle timeout timers, comprising:
establishing, by a first access point (AP) multi-link device (MLD), a first link between the first AP MLD and a non-AP MLD;
generating a first idle timeout timer for the first link;
receiving, from the non-AP MLD, an indication of one or more links between the non-AP MLD and a second AP MLD; and
transmitting, to the second AP MLD and from the first AP MLD, an indication of the first link; and
in response to determining that one or more link termination criteria are satisfied with respect to the first link, terminating the first link, wherein subsequent to terminating the first link, the non-AP MLD continues to exchange data with the second AP MLD using the one or more links.

2. The method of claim 1, further comprising:
establishing, by the first AP MLD, a second link between the first AP MLD and the non-AP MLD; and
generating a second idle timeout timer for the second link.

3. The method of claim 2, further comprising transmitting, to the second AP MLD and from the first AP MLD, an indication of the second link.

4. The method of claim 1, further comprising transmitting, to the second AP MLD and from the first AP MLD, an indication that the first link has been terminated.

5. The method of claim 1, further comprising receiving, by the first AP MLD and from the second AP MLD, an indication that the one or more links to the second AP MLD have been terminated.

6. The method of claim 1, wherein determining that one or more link termination criteria are satisfied with respect to the first link comprises determining that the first idle timeout timer has expired.

7. The method of claim 1, wherein determining that one or more link termination criteria are satisfied with respect to the first link comprises determining that the non-AP MLD has requested termination of the first link.

8. A method for idle timeout coordination between wireless access points, comprising:
establishing, by a first access point (AP) multi-link device (MLD), a first link between the first AP MLD and a non-AP MLD;
generating a first idle timeout timer for the non-AP MLD with respect to the first AP MLD;
transmitting, to a second AP MLD, a first value of the first idle timeout timer;
receiving, from the second AP MLD, a second value of a second idle timeout timer associated with the non-AP MLD with respect to the second AP MLD; and
in response to determining that the second value is greater than the first value, setting the first idle timeout timer to the second value.

9. The method of claim 8, further comprising:
transmitting, to the second AP MLD, a third value of the first idle timeout timer;
receiving, from the second AP MLD, a fourth value of the second idle timeout timer; and
in response to determining that the third value is greater than the fourth value, refraining from resetting the first idle timeout timer.

10. The method of claim 9, wherein, in response to receiving the third value of the first idle timeout timer and determining that the third value is greater than the fourth value, the second AP MLD sets the second idle timeout timer to the third value.

11. The method of claim 8, wherein the first AP MLD periodically exchanges values of the first idle timeout timer with the second AP MLD.

12. The method of claim 8, wherein transmitting the first value of the first idle timeout timer is performed in response to determining that the first idle timeout timer is within a threshold time from expiring.

13. The method of claim 8, wherein transmitting the first value of the first idle timeout timer is performed in response to receiving the second value of the second idle timeout timer.

14. A system, comprising:
one or more computer processors; and
a memory containing a program which when executed by the one or more computer processors performs an operation, the operation comprising:
establishing, by a first access point (AP) multi-link device (MLD), a first link between the first AP MLD and a non-AP MLD;
generating a first idle timeout timer for the first link;
receiving, from the non-AP MLD, an indication of one or more links between the non-AP MLD and a second AP MLD; and
transmitting, to the second AP MLD and from the first AP MLD, an indication of the first link; and
in response to determining that one or more link termination criteria are satisfied with respect to the first link, terminating the first link, wherein subsequent to terminating the first link, the non-AP MLD continues to exchange data with the second AP MLD using the one or more links.

15. The system of claim 14, the operation further comprising:
establishing, by the first AP MLD, a second link between the first AP MLD and the non-AP MLD; and
generating a second idle timeout timer for the second link.

16. The system of claim 15, the operation further comprising transmitting, to the second AP MLD and from the first AP MLD, an indication of the second link.

17. The system of claim 14, the operation further comprising transmitting, to the second AP MLD and from the first AP MLD, an indication that the first link has been terminated.

18. The system of claim 14, the operation further comprising receiving, by the first AP MLD and from the second AP MLD, an indication that the one or more links to the second AP MLD have been terminated.

19. The system of claim 14, wherein determining that one or more link termination criteria are satisfied with respect to the first link comprises determining that the first idle timeout timer has expired.

20. The system of claim 14, wherein determining that one or more link termination criteria are satisfied with respect to the first link comprises determining that the non-AP MLD has requested termination of the first link.
